(19) United States
(12) Patent Application Publication
(10) Pub. No.: US 2013/0173364 A1
(43) Pub. Date: Jul. 4, 2013

(54) CREDIT CARD REWARDS PROGRAM

(71) Applicants: Janssen Choong Cheng Shien, Vancouver (CA); Andrew Moss, Wellesley, MA (US)

(72) Inventors: Janssen Choong Cheng Shien, Vancouver (CA); Andrew Moss, Wellesley, MA (US)

(73) Assignee: Spark Commerce, Inc., Wellesley, MA (US)

(21) Appl. No.: 13/527,985

(22) Filed: Jun. 20, 2012

Related U.S. Application Data
(60) Provisional application No. 61/582,979, filed on Jan. 4, 2012.

(51) Int. Cl. G06Q 30/02

(52) U.S. Cl. 705/14.16; 705/14.27

(57) ABSTRACT

Systems and methods are provided which enable a consumer to accept a promotional offer for a credit card-based reward program without having to supply a credit card number at the time of acceptance. For example, after acceptance, a credit card number associated with the consumer may be retrieved from an entity to which the consumer previously supplied it, such as a publisher (e.g., e-commerce website), and the retrieved number may then be used in relation to the reward program.

### RELATED APPLICATION

This application claims the benefit under 35 U.S.C. §119(e) of the filing date of U.S. Provisional Application Ser. No. 61/582,979, filed Jan. 4, 2012, bearing Attorney Docket No. W1015.70000US00, entitled “CREDIT CARD REWARDS PROGRAM,” the entirety of which is incorporated herein by reference.

### BACKGROUND

Credit card-based reward programs, whereby a consumer who holds a credit card account is presented with a promotional offer which, when accepted, causes a benefit to accrue to the consumer (e.g., via the credit card account), are known. In some conventional credit card-based reward programs, a consumer is sent a promotional offer in an email which includes a link that the consumer may click to access and/or register for the reward program. In some other conventional credit card-based reward programs, a consumer may receive a promotional offer via text message, via a social networking service (e.g., Facebook, Twitter, etc.) or using other techniques.

### SUMMARY

With conventional credit card-based reward programs, a consumer to whom a promotional offer is presented supplies his/her credit card number at the point in time at which he/she accepts the promotional offer. The inventors have appreciated that requiring a consumer to supply a credit card number to accept a promotional offer can discourage the consumer from accepting. As such, some embodiments of the present invention provide techniques whereby a consumer may accept a promotional offer for a credit card-based reward program without having to supply a credit card number at the time of acceptance. Rather, in some embodiments of the invention, an entity to which the consumer has previously supplied the credit card number may provide it (e.g., subsequent to acceptance) for use in relation to the reward program. By removing the need for a consumer to supply a credit card number at the time of acceptance, embodiments of the invention may enable the consumer to enjoy the benefits of a credit card-based reward program without fear of putting his/her credit card account at risk, and may enable a significant hurdle to getting consumers to accept promotional offers to be overcome.

In some embodiments of the invention, a reward system causes a promotional offer to be presented to the consumer during an online interaction between the consumer and a publisher, which may, for example, be an e-commerce website. The consumer may have provided his/her credit card number to the publisher (e.g., he/she may have provided it to make a purchase during the online interaction, may have previously registered it with the publisher, etc.). The consumer may accept the promotional offer during the online interaction without having to provide the credit card number to accept the offer. The promotional offer may, for example, specify a benefit that will accrue to the consumer upon use of a credit card (e.g., the credit card associated with the number previously provided) in a particular manner, such as by using the card to make a purchase of at least a minimum amount from a merchant. Upon the consumer accepting the promotional offer, the publisher may provide the credit card number to the reward system for use in relation to the reward program. The reward program may employ the credit card number to determine whether the consumer uses the credit card in the manner specified by the promotional offer. For example, the reward system and/or a data provider may compare the credit card number to transaction data (e.g., provided by one or more merchants). When it is determined that the consumer has used the credit card in the specified manner, the reward system may cause the benefit to accrue to the consumer. For example, a monetary and/or non-monetary credit may be applied to the credit card account and/or another account, and/or other goods and/or services may be presented to the consumer. The consumer may then be notified of the benefit.

The foregoing description relates to only one example implementation of some aspects of the invention. Numerous variations on this example are possible, and some of these variations are described herein. As such, the foregoing represents a non-limiting summary of some embodiments of the invention. Other embodiments may be reflected in the attached claim listing.

### BRIEF DESCRIPTION OF DRAWINGS

The accompanying drawings are not intended to be drawn to scale. In the drawings, each identical or nearly identical component as illustrated in various figures is represented by a like numeral. For purposes of clarity, not every component may be labeled in every drawing. In the drawings:

FIG. 1 is a block diagram depicting an example process whereby a consumer may register for, and receive benefits of, a credit card-based reward program, without having to supply a credit card number to accept a promotional offer for the reward program, in accordance with some embodiments of the invention;

FIG. 2 is an example screen interface portion depicting an example promotional offer for a credit card-based reward program, in accordance with some embodiments of the invention;

FIG. 3 is a flowchart depicting an example process whereby a promotional offer for a credit card-based reward program may be shared by a consumer with one or more other consumers, in accordance with some embodiments of the invention; and

FIG. 4 is a block diagram depicting an example computer system with which aspects of some embodiments of the invention may be implemented.

### DETAILED DESCRIPTION

Some embodiments of the invention provide systems and methods which enable a consumer to accept a promotional offer for a credit card-based reward program without having to supply a credit card number at the time of acceptance. For example, upon the consumer's acceptance of the promotional offer, the credit card number may be received from an entity to which the consumer previously supplied it, such as a publisher. The credit card number may then be used in relation to the reward program, such as to determine whether the consumer uses the card in a manner specified by the promotional offer, and/or to cause a benefit to accrue to the consumer when this occurs.

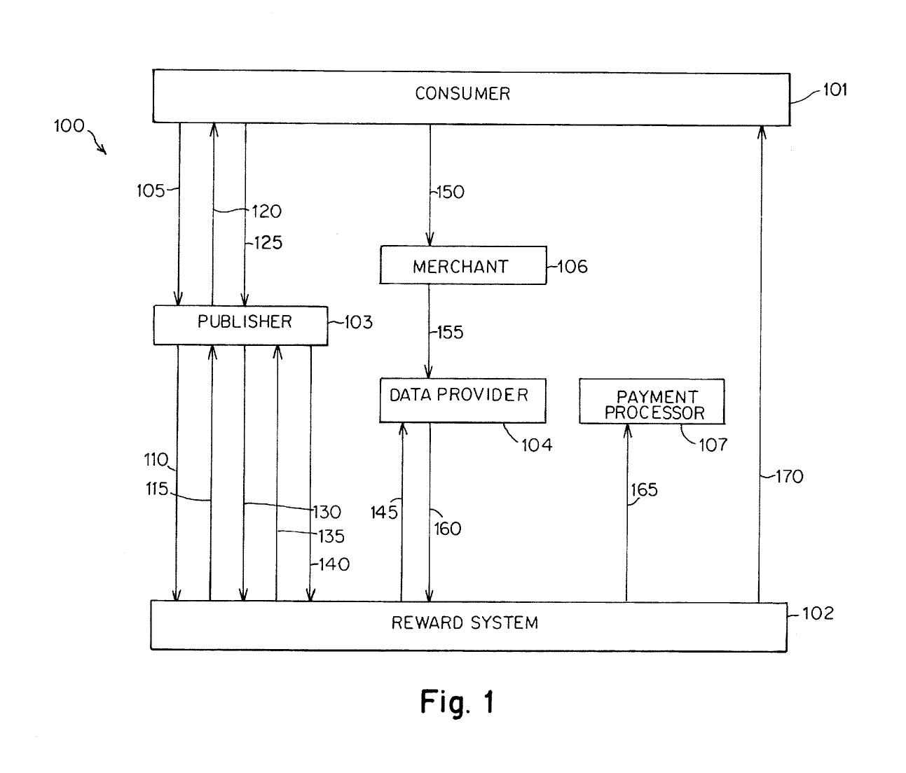

FIG. 1 depicts an example process 100 whereby a consumer may accept a promotional offer for a credit card-based reward program without having to supply a credit card number at the time of acceptance, in accordance with some embodiments of the invention. Example process 100 includes acts and/or processing performed by consumer 101, reward system 102, publisher 103, data provider 104, merchant 106 and payment processor 107. It should be appreciated that the titles of process participants in FIG. 1 are provided merely for convenience and ease of explanation, and do not denote any characteristic of any participant. For example, consumer 101 need not be a human being, and may comprise any one or more entities which hold a credit card account, such as one or more businesses, academic institutions, and/or other entities. Publisher 103 may comprise any one or more entities which communicate (e.g., via the World Wide Web, email, text message, message sent via a social networking service, or using any other suitable vehicle(s) and/or technique(s)) with consumer 101. For example, in some embodiments, a publisher 103 may comprise as an e-commerce website, one or more mobile applications designed to transact with a consumer via a mobile device, a website or application designed for non-commercial purposes, an individual with or without an online presence, and/or any other suitable entity. If publisher 103 comprises an online property and/or a mobile application, then it need not be designed to support the purchase of consumer goods and/or services, and may comprise any one or more entities equipped to transact with a consumer using a credit card. For example, publisher 103 may comprise a utility, a bank, a credit bureau, and/or any other suitable entity. Embodiments of the invention are not limited to being implemented in any particular manner.

Reward system 102 may be any entity that facilitates credit card-based reward programs. One example of a reward system for facilitating credit card-based reward programs is that which is operated by Spark Commerce, Inc., the assignee of the present application, although it should be appreciated that a reward system implemented or used accordance with embodiments of the invention need not have any particular characteristic which is shared by the assignee.

Data provider 104 may comprise any one or more entities capable of receiving and/or processing data relating to credit card transactions. Merchant 106 may, for example, comprise one or more entities with which consumer 101 may transact. For example, in some embodiments, merchant 106 may comprise a “bricks and mortar” retailer, a retailer having an online and offline presence, a retailer having only an online presence, or any other one or more entities. In other embodiments, merchant 106 may comprise an individual, such as an individual who wishes to send a promotional (e.g., reward) offer to consumer 101. Payment processor 107 may comprise any one or more entities having a capability to process payment transactions, such as payments to be credited to a credit card account and/or one or more other types of accounts. For example, payment processor 107 may comprise an entity equipped to apply monetary and/or non-monetary credits and/or debits in relation to credit card accounts and/or other account types. The role of each of these participants in example process 100 is described in detail below.

At the start of example process 100, consumer 101 makes a purchase with publisher 103 in act 105. For example, if publisher 103 is an e-commerce web site, then act 105 may comprise consumer 101 purchasing goods and/or services offered for sale on the site. In performing this purchase, consumer 101 may enter a credit card number on a web page, may indicate that a credit card number previously supplied to publisher 103 should be used for the purchase, or may otherwise designate a credit card number.

Example process 100 then proceeds to act 110, in which publisher 103 sends a request for a promotional offer “unit” for presentation to consumer 101 to reward system 102. In some embodiments, after consumer 101 has designated a credit card for use in the purchase, and prior to presenting a so-called “Thank You” page to consumer 101 indicating to the consumer that the purchase has been completed, publisher 103 may send a request to reward system 102 for a promotional offer unit for presentation to consumer 101. However, a promotional offer unit may be requested at any suitable juncture, as embodiments of the invention are not limited in this respect.

In some embodiments, a request for a promotional offer unit may include various items of data. For example, in some embodiments of the invention, a request may include a unique identifier for the transaction completed in act 105, which may later be employed by reward system 102 and publisher 103, as described further below.

A request for a promotional offer unit may, in some embodiments, also include other items of data, such as items which may enable reward system 102 to identify a targeted and relevant promotional offer to present to consumer 101. For example, publisher 103 may send data describing consumer 101, any goods and/or services currently and/or previously purchased by consumer 101 from publisher 103, and/or other information which may be useful in identifying a promotional offer likely to be accepted by consumer 101. Other data on the consumer may include (as examples) his/her name, email address, telephone number (e.g., mobile telephone number), billing address, shipping address, and/or demographic information (e.g., gender, age, income, occupation, and/or other data). Data on a purchase may include (as examples) a transaction amount, a subset (e.g., last four digits) of the credit card number used to make the purchase, the credit card type, and/or other information. Data on a purchase may also, or alternatively, identify one or more goods and/or services purchased by the consumer. For example, if the consumer purchased movie tickets in act 105, then the data on the purchase may identify the movie, the theater address, the number of tickets, a movie genre or category, the show time and date, and/or other data. Any information may be included in a request for a promotional offer unit, as embodiments of the invention are not limited in this respect.

Publisher 103 may employ any suitable tool(s) and/or technique(s) to send a request for a promotional offer unit to reward system 102. For example, a request and/or accompanying data may comprise a JavaScript Object Notation (JSON) tag in which various information (e.g., identifying and/or describing the consumer, purchase, etc.) may be encrypted and/or encoded.

At the completion of act 110, example process 100 proceeds to act 115, wherein reward system 102 identifies an offer to be presented to consumer 101, and sends information descriptive of the offer to publisher 103. In some embodiments, reward system 102 may identify an offer by executing one or more algorithms on data sent by publisher 103 in act 110. Using the movie ticket purchase example given above to illustrate, reward system 102 may, using the show time and date, and theater address, to determine that an offer for cash back upon consumer 101 using a particular credit card at a restaurant near the theatre may be presented. A promotional offer be identified using any suitable technique, and comprise any suitable benefit for the consumer, whether now known or later developed. Embodiments of the invention are not limited in this respect.

Example process 100 then proceed to act 120, wherein publisher 103 presents the promotional offer to consumer 101. This may be performed in any of numerous ways. In some embodiments, the promotional offer may be included on a web page presented by publisher 103 to consumer 101, such as on a “Thank You” page indicating to consumer 101 that a purchase has been completed, or on one or more other web pages. Of course, embodiments of the invention are not limited to this particular manner of implementation. A promotional offer may be presented using any suitable vehicle, which may or may not include a web page. If a web page is used, then a promotional offer may be presented thereon using any suitable technique. For example, a promotional offer may be presented via a lightbox, a pop-up box, as in-line content (e.g., embedded within content describing a purchase by consumer 101 from publisher 103), and/or via any other suitable display technique, whether now known or later developed.

It should be appreciated that embodiments of the invention are not limited to presenting only a single promotional offer to a consumer. Any suitable number of offers may be presented to a consumer. Moreover, it should be appreciated that although example process 100 includes a promotional offer being presented to consumer 101 at the completion of a purchase from publisher 103, embodiments of the invention are not limited to presenting a promotional offer at any particular juncture. An offer may be presented at any suitable interaction point(s) between consumer 101 and publisher 103, including prior to a purchase being completed, or at any other suitable time.

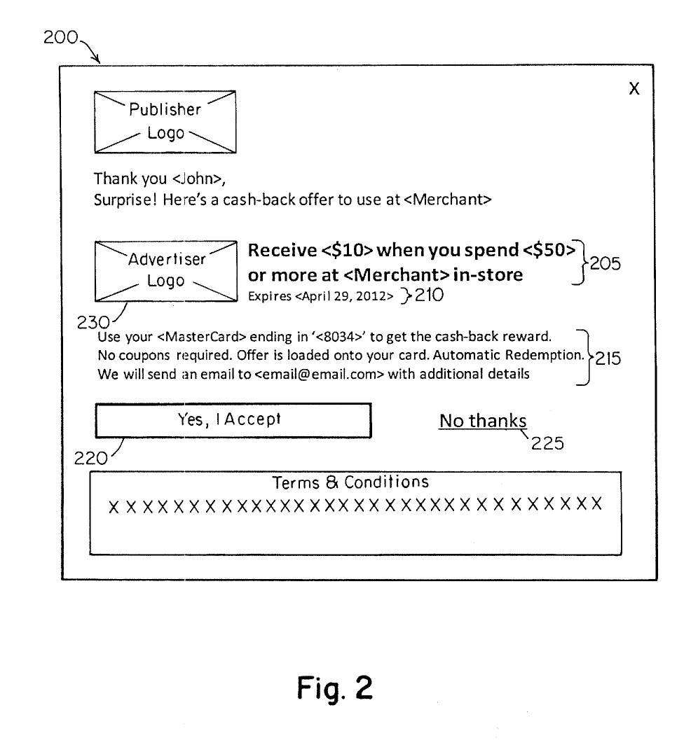

FIG. 2 depicts an example “lightboxed” promotional offer 200, which includes offer details 205 (in the example shown, indicating that the consumer may receive $10 cash back with a purchase of $50 or more at merchant 106), expiration date specification 210 (in this example, Apr. 29, 2012), details 215 (in this example, providing instructions on the credit card to be used and indicating no need to present any coupon at the time of purchase to the merchant), acceptance mechanism 220 (in the example shown, a link), and decline mechanism 225 (also a link). As noted above, a promotional offer may include any suitable information, and facilitate a consumer's acceptance via any suitable mechanism, as embodiments of the invention are not limited in this respect.

Example process 100 then proceeds to act 125, wherein consumer 101 accepts the promotional offer presented in act 120, and then to act 130, wherein publisher 103 provides an indication of the consumer's acceptance to reward system 102. In some embodiments, publisher 103 may include with the indication the unique identifier for the transaction performed in act 105, although embodiments of the invention are not limited to such an implementation.

At the completion of act 130, example process 100 proceeds to act 135, wherein reward system 102 sends a request to publisher 103 for a credit card number associated with consumer 101, such as the credit card number used by consumer 101 to perform the transaction in act 105, a credit card number specified by the promotional offer presented in act 120 (if different from the credit card number used in act 105), and/or any other suitable credit card number which may be employed to provide a benefit to consumer 101. In some embodiments, the request sent by reward system 102 in act 135 specifies the unique identifier for the transaction performed in act 105, which may enable publisher 103 to identify a credit card number associated with the consumer and/or transaction. Of course, embodiments of the invention are not limited to being implemented in this manner, as any suitable technique(s) may be employed to identify a credit card number associated with consumer 101.

In some embodiments, act 135 may be performed in a secure manner. For example, reward system 102 may send the request from a specific, “white-listed” Internet Protocol (IP) address that is known to publisher 103 to be associated with reward system 102. The request may, for example, be sent to a specific endpoint (e.g., Universal Resource Locator (URL), IP address, etc. for one or more web servers and/or services) associated with publisher 103, and employ the HTTP Secure (HTTPS) protocol, Secure Sockets Layer (SSL) protocol, and/or any other suitable protocol(s), to achieve one or more security objectives.

Any suitable tool(s) and/or techniques may be used to send a request to publisher 103. As one example, in an embodiment wherein the request includes a unique identifier for the transaction and/or consumer, the request may take the form https://publisheturl?id=<uniqueIdentifier>, where “uniqueIdentifier” comprises the unique identifier. However, embodiments of the invention are not limited to such an implementation, as a request may take any suitable form.

At the completion of act 135, example process 100 proceeds to act 140, wherein publisher 103 responds to the request by providing a credit card number associated with consumer 101 to reward system 102. Act 140 may, for example, also be performed in a manner designed to achieve various security objectives. For example, the credit card number may be masked via encryption, encoding and/or using any other suitable technique. In this respect, publisher 103 may, for example, be provided with a public key for encryption of information included in a response sent to reward system 102. As illustration, an example in which the credit card number is included within a JSON response which provides a random salt, the response may take the form:

{ status: ‘success’,

creditDataSet:

′f3ec4808533d4782a45f9ea0a252218bc21a805323d70dcc0362dfab3c5d3a23ca5a7e7337

4df1d151013c4bcc3c178acf9e98b14177cd2b8b276ec2d423dbca938ad98f20e53ba
665aa431c4dc398098cf2bb03210f81d748aacf27e411f3dbb397ad1f891a82814875d
8bb6866d122b90ed40bbd54a71a89762282e84683c4f927000dbe46’}

wherein creditDataSet in unencrypted form includes:
{ number: ‘4111390229312932’, exp: ‘0312’, randomSalt:

‘092d8fe93129231s2323dsjw2’ }

As with act 135, act 140 may be accomplished via HTTP and SSL, or any other one or more suitable secure or non-secure data transport protocols, as embodiments of the invention are not limited in this respect.

Example process 100 then proceeds to act 145, wherein reward system 102 provides the credit card number received from publisher 103 in act 140 to data provider 104. In the example process shown in FIG. 1, data provider 104 may receive data describing transactions performed by merchant 106, and compare the transaction data to the supplied credit card number, or a portion or derivation thereof, to identify usage of the associated credit card.

It should be appreciated that not all embodiments of the invention may employ a data provider 104 to compare transaction data to a credit card number, as is in example process 100. For example, in some embodiments, reward system 102 may be provided transaction data (e.g., by merchant 106 and/or other merchants), and compare that transaction data to the credit card number received in act 140. Embodiments of the invention are not limited to the specific example process shown in FIG. 1.

In processes in which a data provider is employed to compare transaction data to a credit card number, delivery of the credit card number to the data provider may be accomplished using any suitable technique, such as a technique designed to achieve security objectives. For example, similar techniques to those described above in relation to acts 135 and 140, and/or other techniques, may be employed.

At the completion of act 145, example process 100 proceeds to act 150, wherein consumer 101 uses the credit card for a purchase with merchant 106, and then to act 155, wherein merchant 106 provides data describing the transaction to data provider 104. Data provider 104 then compares the transaction data sent in act 155 to the credit card number supplied by reward system 102 in act 145, and identifies a match.

Example process 100 then proceeds to act 160, wherein data provider 104 provides an indication of the match to reward system 102. This may be performed in any of numerous ways. In some embodiments, data provider 104 may indicate an identified match by providing data on the associated transaction to reward system 102.

Example process 100 then proceeds to act 165, wherein reward system 102 determines that the transaction described by the data supplied in act 160 represents a use of the credit card which satisfies the terms of the promotional offer presented to consumer 101 in act 120, and instructs payment processor 107 to provide a benefit to the consumer. As noted above, a benefit may take any of numerous forms. For example, in some embodiments, a benefit may comprise a monetary and/or non-monetary credit, which may be applied to the credit card account and/or another account. For example, a benefit may comprise a “cash back” award and/or non-monetary “points” (e.g., airline miles) applied to a credit card account. In another example, a monetary credit may be applied to another type of account (e.g., a PayPal or other monetary account). A benefit need not be credited to an account, however. For example, a benefit may be sent to the consumer, such as in the form of one or more coupons redeemable for goods and/or services (e.g., at certain merchant locations or websites), or in any other suitable form. Any type of benefit may be provided, as embodiments of the invention are not limited in this respect.

At the completion of act 165, example process 100 proceeds to act 170, wherein reward system 102 notifies consumer 101 of the benefit having been provided. This may be performed in any of numerous ways. For example, reward system may notify consumer 101 via email, text message, a message sent via a social networking web site, and/or using any other suitable technique(s).

At the completion of act 170, example process 100 completes.

It should be appreciated that the example process shown in FIG. 1 represents one possible implementation of some embodiments of the invention, and that numerous variations on this example process are possible. For example, any of the acts described above may be performed in a different manner than that which is described, acts may be performed in a different sequence than that which is described, any one or more of the described acts may be omitted or replaced by other acts, and/or additional acts not described above may be performed. Embodiments of the invention are not limited to any particular manner of implementation.

It should also be appreciated that although the example process described above involves a single credit card number being registered for a reward program, embodiments of the invention are not limited to such an implementation, as any suitable number of credit cards may be registered for a reward program. As a result, one possible variation on example process 100 is that consumer 101 employs a first credit card to make a purchase from publisher 103 in act 105, and then a second credit card to make a purchase from merchant 106 in act 150 to satisfy the terms of a promotional offer. If this occurs, a benefit may be applied in act 165 to one of the credit card accounts, to both credit card accounts, and/or to another account (which may or may not be associated with a credit card). If more than one credit card is registered for a reward program, then act 140 may, for example, include publisher 103 sending more than one credit card number to reward system 102 for use in relation to the reward program. Any of numerous implementations are possible.

It should further be appreciated that although example process 100 involves a promotional offer being presented to consumer 101 at the time the consumer makes a purchase, not all embodiments are limited to a promotional offer being presented at the time of purchase, or in association with a purchase. For example, one possible variation on example process 100 is that consumer 101 is presented with a promotional offer in act 120 (e.g., after completing a purchase in act 105), but neglects to accept or decline the offer at that time. If this occurs, the promotional offer may be communicated to consumer 101, for example, at some time after the purchase from publisher 103 has been completed. For example, a promotional offer may be emailed to the consumer a day or two after the purchase was completed. In this variation, the promotional offer that is ultimately communicated to the consumer may be different than one which might have been presented to the consumer at the time the purchase was completed. Using the movie ticket purchase example given above to illustrate, while an offer presented at the time of purchase may have been a cash back offer for use at a restaurant nearby the movie theater, a promotional offer presented later may be for something altogether different, given that the consumer, after he/she has attended the movie, may be less likely to be in the movie theater's vicinity than right after show time. A promotional offer presented at some time after the time of purchase may, for example, be identified using data relating to the consumer, one or more previous transactions, and/or any other suitable information.

In another possible variation on example process 100, presentation of a promotional offer to consumer 101 may be unrelated to a purchase by the consumer from publisher 103. For example, a promotional offer may be presented to a consumer if the consumer did not purchase anything from the publisher, either during a particular online interaction or at any time. Instead, if the consumer has previously provided a credit card number to publisher 103, or if the credit card number be retrieved from one or more entities (e.g., other publishers), then the credit card number may be used in connection with a promotional offer, in accordance with some embodiments of the invention.

Another possible variation on example process 100 wherein a promotional offer is not presented to consumer 101 at the time of purchase is one wherein a promotional offer is presented in an attempt to induce the consumer to make a purchase. For example, if the consumer's physical location is known (e.g., because that location is communicated to reward system 102, such as via a mobile device carried by the consumer), then a location-based promotional offer may be communicated to the consumer. (It should be appreciated that, in such a variation, a promotional offer may not be presented to the consumer by a publisher. For example, a promotional offer may be delivered by text message. Any of numerous implementations are possible.) For example, if it is determined that the consumer is currently at a particular retailer's physical location, then a promotional offer for a discount on purchases at that retailer, or a different nearby retailer, may be presented to the consumer (e.g., via the mobile device).

For this variation, a credit card number associated with the consumer may be obtained in any of numerous ways. In one example, reward system 102 may obtain a credit card number associated with the consumer from publisher 103, such as by submitting a request to publisher 103 which includes information identifying the consumer. In another example, reward system 102 may access a credit card number associated with consumer 101 from electronic storage. For example, consumer 101 may have previously registered for a reward program through reward system 102, and reward system 102 may have stored a credit card number for later use. Any of numerous implementations are possible.

In the variations on example process 100 which are described above, a promotional offer may be communicated to a consumer using any suitable tool(s) and/or technique(s). For example, a promotional offer may be sent via e-mail, social networking service message, text message, and/or in any other suitable manner. Further, a promotional offer may be accepted by a consumer in any of numerous ways. For example, if the promotional offer is emailed to a consumer, then the consumer may accept via return e-mail, by “clicking through” the e-mail (e.g., via a link provided in the email), or in any other suitable manner. If the promotional offer is sent to the consumer via a social networking service, the consumer may accept by sending a message via the same social networking service, or in any other suitable manner. It should be appreciated that a consumer need not accept a promotional offer sent via one medium by sending an acceptance via the same medium. For example, a consumer may accept an emailed promotional offer via text message. Any suitable tool(s) and/or technique(s) may be employed, as embodiments of the invention are not limited in this respect.

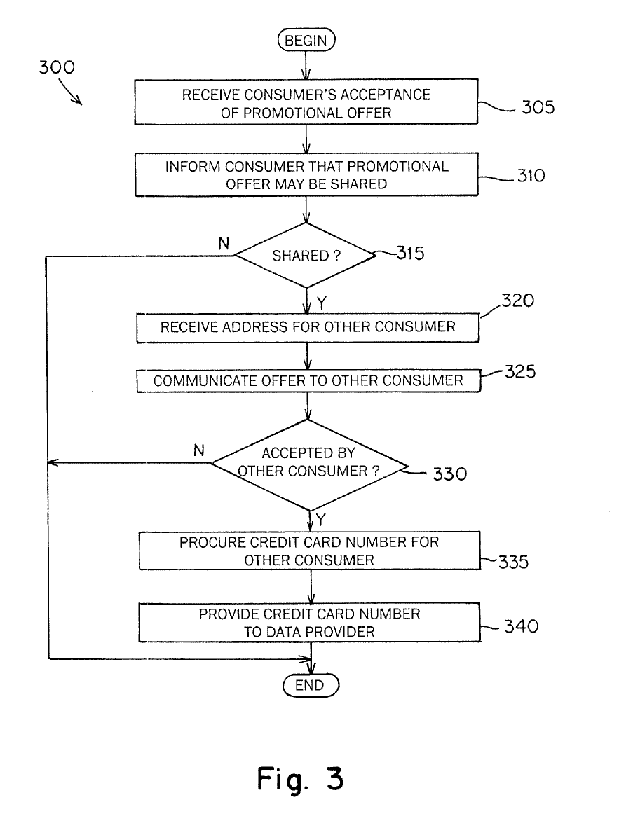

In some embodiments of the invention, a consumer to whom a promotional offer is presented may share the offer with one or more other consumers. Sharing may be performed in any of numerous ways. An example process 300 whereby a consumer may share a promotional offer with one or more other consumers is shown in FIG. 3.

At the start of example process 300, a consumer's acceptance of a promotional offer is received in act 405. As described above in relation to example process 100, a consumer may accept a promotional offer in any of numerous ways, such as in the manner described above in relation to act 125.

Example process 300 then proceeds to act 310, wherein the consumer is informed that the promotional offer may be shared with one or more other consumers. This, too, may be performed in any of numerous ways. For example, a confirmation message sent to the consumer upon his/her acceptance may indicate that the promotional offer may be shared. In some embodiments, a promotional offer may be shared with multiple other consumers. The remainder of the description of example process 300, however, assumes that a promotional offer is shared with only one other consumer. If a promotional offer were instead shared with multiple consumers, some or all of the acts described below in relation to a single other consumer with whom the offer is shared may, for example, be repeated for each other consumer.

Example process 300 then proceeds to act 315, wherein a determination is made whether the consumer opts to share the promotional offer with another consumer. If it is determined that the consumer opts to share the promotional offer with another consumer, then example process 300 proceeds to act 320, wherein an address associated with the other consumer is procured. This may be performed in any of numerous ways. For example, the consumer to whom the promotional offer was originally presented may supply an (e.g., e-mail) address, mobile telephone number, username or handle for a social networking service, and/or any other suitable address for the other consumer.

Example process 300 then proceeds to act 325, wherein the promotional offer is communicated to the other consumer. Communication may be accomplished in any of numerous ways (e.g., via e-mail, social networking service, text message, etc.) and may depend on the type of address received in act 320.

Example process 300 then proceeds to act 330, wherein a determination is made whether the promotional offer has been accepted by the other consumer. For example, if the promotional offer was e-mailed to the other consumer in act 325, then act 330 may involve determining whether the other consumer has replied to, “clicked through,” or otherwise indicated acceptance via the e-mail.

If it is determined that the other consumer has accepted the promotional offer, then example process 300 proceeds to act 335, wherein a credit card number associated with the other consumer is procured in act 435. This may be performed in any of numerous ways.

In one example, if the other consumer had previously registered with and provided a credit card number to reward system 102, then the credit card number may be retrieved from storage (e.g., electronic storage). For example, the credit card number may be retrieved using information identifying the other consumer, such as the other consumer's email address and/or any other identifying information.

In another example, if the other consumer had previously registered with and provided a credit card number to publisher 103, then the credit card number may be retrieved from publisher 103. For example, the other consumer's credit card number may be retrieved by submitting a request specifying information identifying the other consumer (e.g., the other consumer's email address, and/or other identifying information), so that publisher 103 may match the identifying information to stored credit card numbers.

In yet another example, the credit card number may be retrieved from a publisher other than publisher 103 (not shown in FIG. 1). For example, if reward system 102 had a pre-existing business relationship with another publisher (e.g., as one of a “network” of publishers through which reward system 102 presented promotional offers to consumers), and the other publisher had a pre-existing relationship with the consumer (e.g., as a result of previous purchases by the other consumer from the other publisher), then reward system 102 may request the other consumer's credit card number from the other publisher. The request need not be sent by reward system 102 to only one other publisher, as any suitable number of publishers other than publisher 103 may receive a request for a credit card number from reward system 102. For example, reward system 102 may send a request to each of multiple publishers in a pre-existing network, using any suitable information to identify the other consumer, and one or more other publishers in the network may respond to the request with the other consumer's credit card number, or a representation (e.g., an encrypted, encoded and/or abbreviated version) thereof. Any of numerous techniques may be employed, as embodiments of the invention are not limited to any particular manner of implementation.

Example process 300 then proceeds to act 340, wherein the credit card number procured in act 335 is provided to a data provider. This may be performed, for example, using the techniques described above in relation to act 145 of example process 100 (FIG. 1). The data provider may then compare the credit card number to transaction data (e.g., supplied by one or more merchants to which the promotional offer relates), to determine whether the other consumer has used the credit card in the manner specified by the promotional offer. At the completion of act 340, example process 300 completes.

It should be appreciated that, as with example process 100 shown in FIG. 1, numerous variations on example process shown in FIG. 3 are possible. For example, any of the acts described above in relation to example process 300 may be performed in a different manner or sequence than that which is described, any one or more acts may be omitted, and any one or more acts may be replaced by other acts not described above. In one example variation on example process 300, act 305 may be omitted, so that a first consumer may share a promotional offer with one or more other consumers without having accepted the promotional offer.

In another example variation on example process 300, an abbreviated version of a credit card number for the “other” consumer with whom a promotional offer is shared may be obtained prior to communicating a promotional offer to the other consumer in act 325, so that the promotional offer may indicate a credit card to which the offer relates. For example, upon receiving an address for the other consumer in act 320, reward system 102 may ask publisher 103 and/or one or more other publishers (e.g., members of a network of publishers) if the publisher(s) possess(es) a credit card number for the other consumer, and if so, for the last four digits of that number, so that a promotional offer subsequently presented to the other consumer may include those digits. The offer may then be presented to the other consumer, and if accepted by the other consumer, the full credit card number may be retrieved (e.g., using the techniques described above, and/or any other suitable techniques.

Numerous other variations on example process 300 are possible. Embodiments of the invention are not limited to any particular manner of implementation.

In some embodiments of the invention, a promotional offer which is presented to a consumer may be conditional, in that to receive a benefit, the consumer may be asked to take one or more actions. For example, a promotional offer may specify that to accept, the consumer should pass on the offer to a particular quantity of other consumers (e.g., friends), complete a minimum number of transactions with a merchant before a benefit may be received, and/or take another type of action. Any suitable condition or combination of conditions may be specified by a promotional offer.

In some embodiments of the invention, one or more individuals may act as a publisher and/or a merchant in the example processes described above. For example, in some embodiments, one consumer may create and/or send a promotional (e.g., reward) offer to another consumer for redemption (e.g., via email, text message, and/or using any other suitable communication technique(s)). For example, consumer A may create a $10 reward offer which consumer B may redeem, and cause it to be sent to Consumer B. Consumer B may then redeem the offer, or modify it and cause it to be sent to one or more other consumers. For example, Consumer B may modify a received $10 offer to change the value to $15 (e.g., by purchasing the additional $5 value, redeeming a credit, or using any other method(s)), and cause it to be sent to Consumer C, so that Consumer C receives a reward offer of $15. Consumer C may then redeem the offer, or pass it along to yet another consumer. Any suitable entity may act as a publisher and/or merchant, and promotional offers may be created, modified and/or communicated using any suitable technique(s).

The example techniques described above enable a consumer to accept a promotional offer for a credit card-based reward program without having to supply a credit card number at the time of acceptance. Any or all of the entities described above may enjoy significant benefits as a result of such an arrangement. For example, the consumer may be given the opportunity to enjoy significant savings from reputable merchants, via a promotional offer that costs nothing to accept and may obligate him/her to do nothing. The publisher, if online presentation of the promotional offer is sponsored by a merchant, may earn additional revenue, become affiliated with the merchant in the consumer's eyes (which may boost brand equity), and enjoy other benefits associated with presenting appealing and relevant content to consumers. A merchant may boost brand awareness through presentation of a promotional offer to consumers on a publisher's site, acquire new, profitable customers via consumer acceptance of promotional offers, and be able to more effectively measure the payback associated with its promotional activities (e.g., as opposed to advertising).

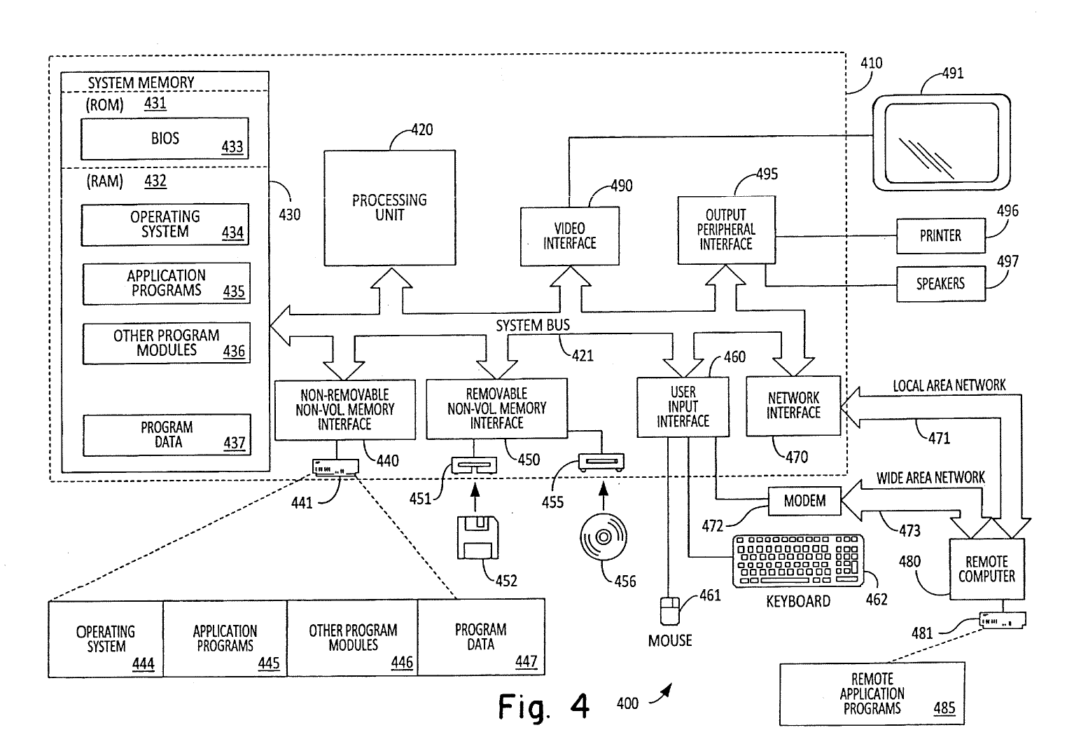

FIG. 4 illustrates one example of a suitable computing system environment 400 with which aspects of the invention may be implemented. The computing system environment 400 is only one example of a suitable computing environment, and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 4, an example system for implementing the invention includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through an non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through a output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on memory device 481. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising acts of:
(A) causing a promotional offer to be presented to a consumer, acceptance of the promotional offer by the consumer enabling the consumer to benefit from use of a particular credit card in a particular manner; and
(B) receiving an indication that the promotional offer has been accepted by the consumer, wherein acceptance by the consumer is accomplished without the consumer supplying a credit card number identifying the particular credit card at the time of acceptance;
(C) determining that the consumer has used the particular credit card in the particular manner; and
(D) in response to the determining in the act (C), causing a benefit to accrue to the consumer.

2. The method of claim 1, wherein the act (A) comprises causing the promotional offer to be presented by a publisher to the consumer.

3. The method of claim 2, wherein the act (A) comprises causing the promotional offer to be included on a web page that is presented by publisher to the consumer in relation to a purchase by the consumer from the publisher.

4. The method of claim 2, wherein the publisher comprises an e-commerce website.

5. The method of claim 1, wherein the act (A) comprises causing the promotional offer to be presented as one or more of light-boxed content, content in a pop-up window, and inline content.

6. The method of claim 1, wherein the act (B) comprises receiving the credit card number from the publisher.

7. The method of claim 6, wherein the act (A) comprises receiving an identifier from the publisher, and the act (B) comprises supplying the identifier to the publisher in a request for the credit card number.

8. The method of claim 6, wherein the act (C) comprises causing the credit card number to be matched to data describing credit card transactions.

9. The method of claim 1, wherein use of the particular credit card in the particular manner comprises a purchase by the consumer at a particular merchant.

10. The method of claim 9, wherein the purchase is of at least an amount specified in the promotional offer.

11. The method of claim 1, wherein the act (D) comprises one or more of applying a monetary credit to the credit card account, applying a monetary credit to another account held by the consumer, applying a non-monetary credit to the credit card account, applying a non-monetary credit to another account held by the consumer, and providing the consumer one or more goods and/or services.

12. The method of claim 1, wherein the act (A) comprises causing to be presented a promotional offer for which acceptance is conditioned upon the consumer sharing the promotional offer with one or more other consumers, and the act (B) comprises receiving an indication that at least one of the one or more consumers has accepted the promotional offer.

13. The method of claim 1, wherein the act (A) comprises causing to be presented a promotional offer which may be shared with one or more other consumers, and the act (B) comprises receiving an indication that at least one of the one or more consumers has accepted the promotional offer.

14. At least one computer-readable medium having instructions recorded thereon which, when executed by at least one computer, perform a method comprising acts of:
(A) causing a promotional offer to be presented to a consumer, acceptance of the promotional offer by the consumer enabling the consumer to benefit from use of a particular credit card in a particular manner; and
(B) receiving an indication that the promotional offer has been accepted by the consumer, wherein acceptance by the consumer is accomplished without the consumer supplying a credit card number identifying the particular credit card at the time of acceptance;
(C) determining that the consumer has used the particular credit card in the particular manner; and
(D) in response to the determining in the act (C), causing a benefit to accrue to the consumer.

15. The at least one computer-readable medium of claim 14, wherein the act (A) comprises causing the promotional offer to be presented by a publisher to the consumer.

16. The at least one computer-readable medium of claim 15, wherein the act (A) comprises causing the promotional offer to be included on a web page that is presented by publisher to the consumer in relation to a purchase by the consumer from the publisher.

17. The at least one computer-readable medium of claim 15, wherein the publisher comprises an e-commerce website.

18. The at least one computer-readable medium of claim 14, wherein the act (A) comprises causing the promotional offer to be presented as one or more of light-boxed content, content in a pop-up window, and inline content.

19. The at least one computer-readable medium of claim 14, wherein the act (B) comprises receiving the credit card number from the publisher.

20. The at least one computer-readable medium of claim 19, wherein the act (A) comprises receiving an identifier from the publisher, and the act (B) comprises supplying the identifier to the publisher in a request for the credit card number.

21. The at least one computer-readable medium of claim 19, wherein the act (C) comprises causing the credit card number to be matched to data describing credit card transactions.

22. The at least one computer-readable medium of claim 14, wherein use of the particular credit card in the particular manner comprises a purchase by the consumer at a particular merchant.

23. The at least one computer-readable medium of claim 22, wherein the purchase is of at least an amount specified in the promotional offer.

24. The at least one computer-readable medium of claim 14, wherein the act (D) comprises one or more of applying a monetary credit to the credit card account, applying a monetary credit to another account held by the consumer, applying a non-monetary credit to the credit card account, applying a non-monetary credit to another account held by the consumer, and providing the consumer one or more goods and/or services.

25. The at least one computer-readable medium of claim 14, wherein the act (A) comprises causing to be presented a promotional offer for which acceptance is conditioned upon the consumer sharing the promotional offer with one or more other consumers, and the act (B) comprises receiving an indication that at least one of the one or more consumers has accepted the promotional offer.

26. The at least one computer-readable medium of claim 14, wherein the act (A) comprises causing to be presented a promotional offer which may be shared with one or more other consumers, and the act (B) comprises receiving an indication that at least one of the one or more consumers has accepted the promotional offer.

27. A computer system, comprising:
at least one processor programmed to:
(A) cause a promotional offer to be presented to a consumer, acceptance of the promotional offer by the consumer enabling the consumer to benefit from use of a particular credit card in a particular manner; and
(B) receive an indication that the promotional offer has been accepted by the consumer, wherein acceptance by the consumer is accomplished without the consumer supplying a credit card number identifying the particular credit card at the time of acceptance;
(C) determine that the consumer has used the particular credit card in the particular manner; and
(D) in response to the determining in the act (C), cause a benefit to accrue to the consumer.

28. The computer system of claim 27, wherein the at least one processor is programmed to cause the promotional offer to be presented by a publisher to the consumer.

29. The computer system of claim 28, wherein the at least one processor is programmed to cause the promotional offer to be included on a web page that is presented by publisher to the consumer in relation to a purchase by the consumer from the publisher.

30. The computer system of claim 28, wherein the publisher comprises an e-commerce website.

31. The computer system of claim 27, wherein the at least one processor is programmed to cause the promotional offer to be presented as one or more of lightboxed content, content in a pop-up window, and inline content.

32. The computer system of claim 27, wherein the at least one processor is programmed to receive the credit card number from the publisher.

33. The computer system of claim 32, wherein the at least one processor is programmed to receive an identifier from the publisher, and to supply the identifier to the publisher in a request for the credit card number.

34. The computer system of claim 28, wherein the at least one processor is programmed to cause the credit card number to be matched to data describing credit card transactions.

35. The computer system of claim 27, wherein use of the particular credit card in the particular manner comprises a purchase by the consumer at a particular merchant.

36. The computer system of claim 35, wherein the purchase is of at least an amount specified in the promotional offer.

37. The computer system of claim 27, wherein the at least one processor is programmed to cause one or more of applying a monetary credit to the credit card account, applying a monetary credit to another account held by the consumer, applying a non-monetary credit to the credit card account, applying a non-monetary credit to another account held by the consumer, and providing the consumer one or more goods and/or services.

38. The computer system of claim 27, wherein the at least one processor is programmed to cause a promotional offer to be presented for which acceptance is conditioned upon the consumer sharing the promotional offer with one or more other consumers, and to receive an indication that at least one of the one or more consumers has accepted the promotional offer.

39. The computer system of claim 27, wherein the at least one processor is programmed to cause a promotional offer to be presented which may be shared with one or more other consumers, and to receive an indication that at least one of the one or more consumers has accepted the promotional offer.
